(19) United States
(12) Patent Application Publication
(10) Pub. No.: US 2008/0192193 A1
(43) Pub. Date: Aug. 14, 2008

(54) NOISE PREVENTING FILM, LIQUID CRYSTAL DISPLAY DEVICE HAVING THE SAME, AND METHOD FOR MANUFACTURING THE SAME

(75) Inventors: Byung-Chang SHIM, Yongin-si (KR); Hee-Kwon EUN, Seongnam-si (KR); Dong-Wan CHOI, Incheon (KR); Sang-Woo KIM, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/023,123

(22) Filed: Jan. 31, 2008

(30) Foreign Application Priority Data
Feb. 9, 2007 (KR) 10-2007-0013487

(51) Int. Cl. G02F 1/1333; B32B 5/02; B29C 59/04

(52) U.S. Cl. 349/122; 428/457; 428/688; 156/209

(57) ABSTRACT

A noise preventing film includes a base layer, a conductive layer stacked on the base layer, a noise preventing layer stacked on the conductive layer, and a noise preventing particle distributed in the noise preventing layer. An LCD device includes the noise preventing film, and a method for manufacturing the noise preventing film is provided.

This application claims priority to Korean Patent Application No. 10-2007-0013487, filed on Feb. 9, 2007, and all the benefits accruing therefrom under 35 U.S.C. §119, the contents of which in its entirety are herein incorporated by reference.

### BACKGROUND OF THE INVENTION

1. Field of the Invention

The present invention relates to a noise preventing film, a liquid crystal display (“LCD”) device having the same, and a method for manufacturing the same. More particularly, the present invention relates to a noise preventing film, which is capable of removing noise of an audible frequency band, an LCD device having the same, and a method for manufacturing the same.

2. Description of the Related Art

An LCD device displays an image such that each sub pixel, among the sub pixels arranged on a substrate in a matrix form, adjusts light transmittance of a liquid crystal layer according to a video signal. A liquid crystal layer is driven by an electric field formed when a pixel voltage is applied to a pixel electrode and a common voltage is applied to a common electrode, and transmittance is determined by a liquid crystal layer driven by the electric field.

In such an LCD device, a polarity of a common voltage applied to a common electrode is periodically changed in order to prevent deterioration of a liquid crystal layer, which is called “inversion”. There are various inversion methods such as a frame inversion, a line inversion, and a dot inversion. Of these, a line inversion is usually used for small or middle sized LCD devices.

In case of a line inversion, an inversion frequency is in a frequency band of 8 kHz to 13 kHz which is within an audible frequency band of 20 Hz to 20 kHz.

### BRIEF SUMMARY OF THE INVENTION

It has been determined herein that a user may hear high frequency noise while using a conventional LCD device due to the inversion frequency which is within an audible frequency band. In particularly, 13 kHz is a frequency which is most sensitive to an ear of a human being, and such noise due to inversion frequency degrades the quality of an LCD device used in a telecommunication device such as a cellular phone.

The present invention, therefore, provides a noise preventing film in which a noise preventing particle is provided to prevent noise that occurs due to a common voltage swing, an LCD device having the same, and a method for manufacturing the same.

Exemplary embodiments of the present invention provide a noise preventing film including a base layer, a conductive layer stacked on the base layer, a noise preventing layer stacked on the conductive layer, and a noise preventing particle distributed in the noise preventing layer.

The noise preventing particle may include a conductive particle. The conductive particle may include a nickel particle or a nickel-gold alloy particle.

The noise preventing particle may include a bubble filled with low density gas and which has lower density than air. The low density gas may be helium (He).

The noise preventing particle may include both a conductive particle and a bubble filled with low density gas.

Other exemplary embodiments of the present invention provide an LCD device including a thin film transistor (“TFT”) array substrate having a TFT array, an opposite substrate arranged opposite to the TFT array substrate and having a common electrode, a liquid crystal layer injected between the TFT array substrate and the opposite substrate, a common voltage transmitting portion arranged in an edge portion of the TFT array substrate and the opposite substrate and transmitting a common voltage supplied from the TFT array substrate to the opposite substrate, a polarizer film attached on at least one of the TFT array substrate and the opposite substrate, and a noise preventing film that prevents noise, is arranged in the polarizer film, and includes a base layer, a conductive layer stacked on the base layer, a noise preventing layer stacked on the conductive layer, and a noise preventing particle distributed in the noise preventing layer.

The polarizer film may include an extending portion that covers the common voltage transmitting portion to block noise that occurs in the common voltage transmitting portion.

The polarizer film may include a polarizing layer, a retardation film, a first adhesive layer that attaches the polarizing film and the retardation film, and a second adhesive layer adhered to an outer surface of the retardation film.

The noise preventing film may be arranged in at least one of the polarizing layer, the retardation film, and the first and second adhesive layers.

The noise preventing particle may include a conductive particle. The conductive particle may include a nickel particle or a nickel-gold alloy particle. Alternatively, the conductive particle may include a carbon fiber.

The noise preventing particle may include a bubble filled with low density gas and which has lower density than air. The low density gas may be helium (He).

The noise preventing particle may include both a conductive particle and a bubble filled with low density gas.

Still other exemplary embodiments of the present invention provide a method for manufacturing a noise preventing film, the method including moving a first film at a predetermined speed, forming a groove on at least one surface of the first film, and attaching a second film to a groove-formed surface of the first film in a low density gas atmosphere.

The groove may be formed on first and second opposing surfaces of the first film. The second film may be attached to the first surface of the first film, and the second film may be attached to the second surface of the first film. The low density gas in the low density gas atmosphere may be helium (He)

The second film may be attached to the first film in a chamber filled with low density gas or in a low density gas shower atmosphere.

### BRIEF DESCRIPTION OF THE DRAWINGS

The above and other features of the present invention will be described in reference to certain exemplary embodiments thereof with reference to the attached drawings in which:

FIG. 1 is a cross-sectional view illustrating an exemplary noise preventing film according to an exemplary embodiment of the present invention;

FIG. 2 is a cross-sectional view illustrating an exemplary LCD device according to an exemplary embodiment of the present invention;

FIG. 3 is a cross-sectional view illustrating an exemplary TFT array substrate according to an exemplary embodiment of the present invention;

FIG. 4 is a cross-sectional view illustrating an exemplary opposite substrate according to an exemplary embodiment of the present invention;

FIG. 5 is a cross-sectional view illustrating an exemplary polarizer film according to an exemplary embodiment of the present invention;

FIG. 6 is a side view illustrating an exemplary method for manufacturing the exemplary noise preventing film according to an exemplary embodiment of the present invention;

FIG. 7 is an enlarged view illustrating portion A of FIG. 6; and

FIG. 8 is an enlarged view illustrating portion B of FIG. 6.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Reference will now be made in detail to the embodiments of the present invention, examples of which are illustrated in the accompanying drawings, wherein like reference numerals refer to the like elements throughout.

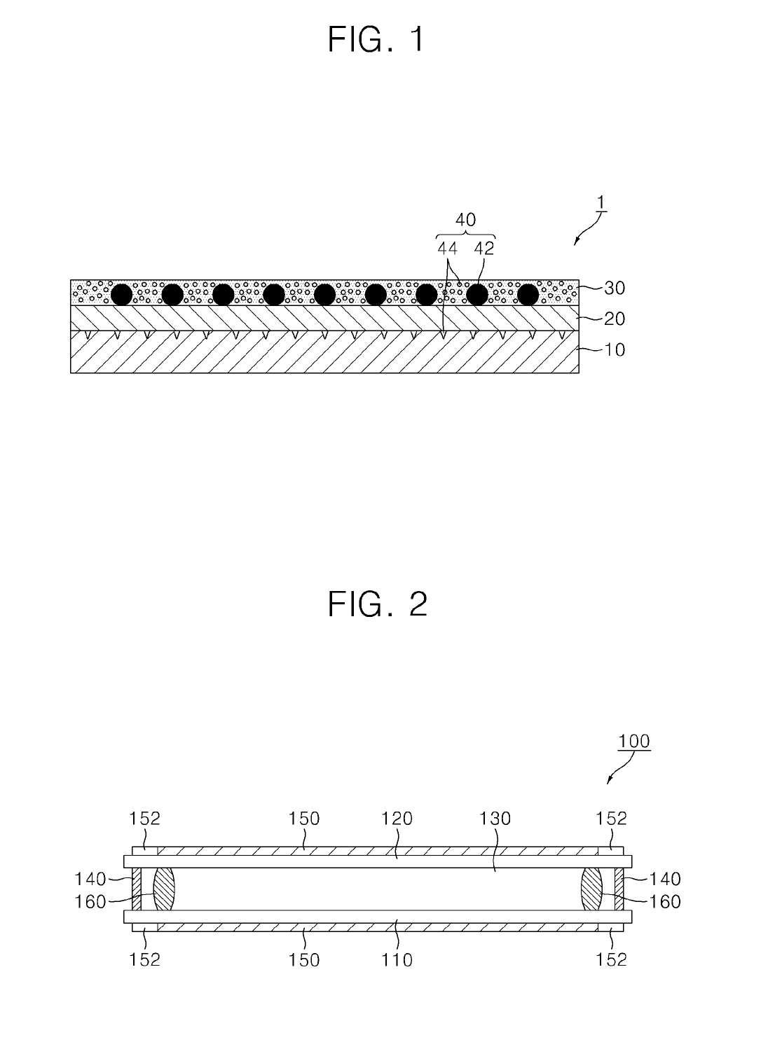

FIG. 1 is a cross-sectional view illustrating an exemplary noise preventing film according to an exemplary embodiment of the present invention. As shown in FIG. 1, the noise preventing film 1 includes a base layer 10, a conductive layer 20, a noise preventing layer 30, and at least one noise preventing particle 40. The base layer 10 serves to maintain a form of the noise preventing film 1. The noise preventing film 1 may be made of a transparent material through which light can transmit if it is contained in a polarizer film or an optical film. In an exemplary embodiment, a tri-acetyl cellulose (“TAC”) film is used as the base layer 10.

The conductive layer 20 is formed on the whole surface, or substantially the entire surface, of the base layer 10. The conductive layer 20 may be made of a transparent material such as indium tin oxide (“ITO”), indium zinc oxide (“IZO”), and indium tin zinc oxide (“ITZO”). The conductive layer 20 enables the noise preventing film 1 to have conductivity.

The noise preventing layer 30 is formed on the conductive layer 20 and may be made of paste. The noise preventing layer 30 absorbs or reflects noise which is within an audible frequency band to thereby remove or reduce the noise. In an exemplary embodiment, a plurality of noise preventing particles 40 are provided, and the noise preventing particles 40 are distributed in the noise preventing layer 30. The noise preventing layer 30 has a structure in which the noise preventing particles 40 are randomly distributed in a paste-like material. The noise preventing particles 40 may be dispersed throughout the noise preventing layer 30.

In exemplary embodiments of the present invention, three examples for the noise preventing particles 40 are suggested.

In a first exemplary embodiment of the noise preventing particle 40, a conductive particle 42 may be provided as the noise preventing particle 40. The conductive particle 42 may be made of a metallic particle such as a nickel particle and a nickel alloy particle (e.g., nickel-gold alloy particle). Alternatively, a conductive organic particle such as a carbon fiber may be used as the conductive particle 42. While particular materials for the conductive particle 42 are described, it would be within the scope of these embodiments to use alternative materials for the conductive particle 42.

Noise within an audible frequency band is efficiently reduced by the conductive particle 42.

In a second exemplary embodiment of the noise preventing particle 40, a bubble 44 filled with a low density gas may be used as the noise preventing particle 40. The bubbles 44 filled with a low density gas may be randomly distributed in the paste of the noise preventing layer 30.

A propagation speed of a longitudinal wave such as sound in a fluid such as gas is in reverse proportion to fluid density. A propagation speed of a longitudinal wave in a gas having a lower density than air is faster than in the air. A frequency of a longitudinal wave is in proportion to a propagation speed. By this principle, noise of an audible frequency band (i.e., 10 kHz to 13 kHz) can be converted to an electronic wave having a frequency which is not within than an audible frequency band.

Since a plurality of bubbles 44 with lower density than air are randomly distributed in the noise preventing layer 30, noise of an audible frequency band that occurs due to a line inversion is converted to noise which deviates from an audible frequency band which is not recognized by a user's ear.

The bubbles 44 may be distributed in either or both of the noise preventing layer 30 and between film layers. In an exemplary embodiment, the bubbles 44 may be provided within a space between the base layer 10 and the conductive layer 20.

In exemplary embodiments of the bubbles 44, Helium (He) having a big density difference with air may be used as a gas having lower density than air.

In a third exemplary embodiment of the noise preventing particle 40, as shown in FIG. 1, both the conductive particle 42 and the bubble 44 filled with low density gas may be used as the noise preventing particle 40. In such an embodiment, a noise preventing effect is greatly increased.

An LCD device having the noise preventing film described above is described below.

FIG. 2 is a cross-sectional view illustrating an exemplary LCD device according to an exemplary embodiment of the present invention. The LCD device 100 of FIG. 2 includes a thin film transistor (“TFT”) array substrate 110, an opposite substrate 120, a liquid crystal layer 130, a common voltage transmitting portion 140, a polarizer film 150, and a noise preventing film (such as shown in FIG. 1).

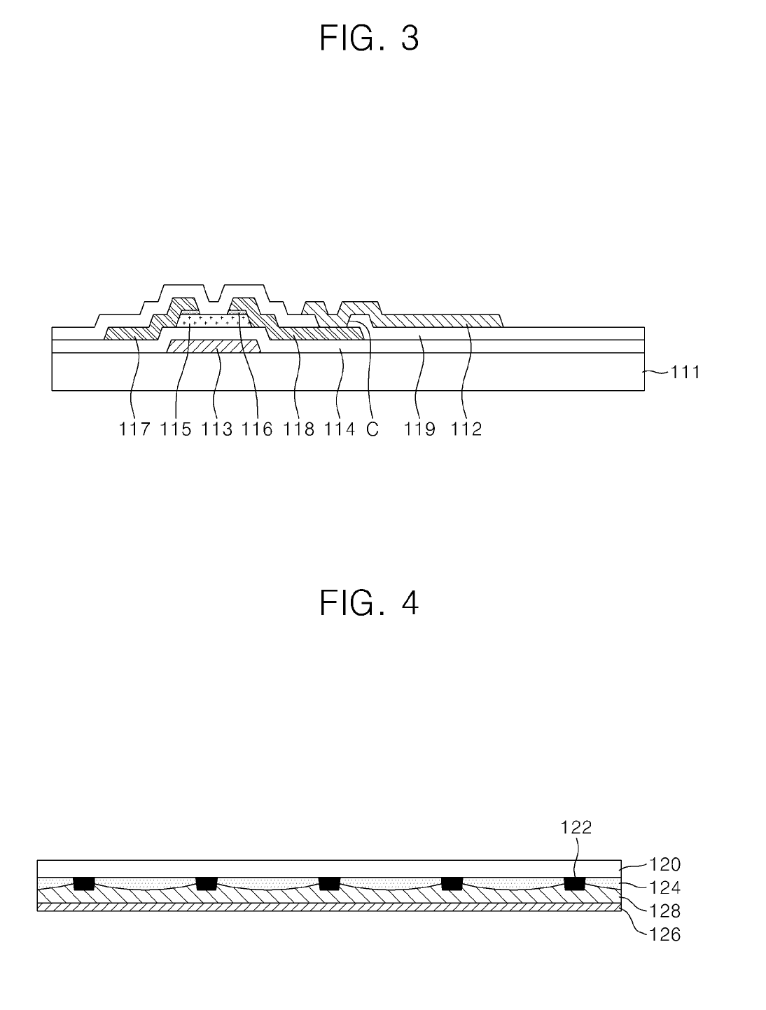

FIG. 3 is a cross-sectional view illustrating an exemplary TFT array substrate according to an exemplary embodiment of the present invention. The TFT array substrate 110 including a plurality of pixel regions, and includes gate lines and data lines which cross and TFTs formed at crossing points of the gate and data lines.

Each gate line supplies a scan signal to a respective TFT. The gate line is arranged on a substrate in a line form substantially in a first direction. The gate line may have a single layer structure or a dual layer structure made of a conductive metal. The gate line is connected to a gate electrode 113 of the TFT.

Each data line is arranged substantially in a second direction, which is perpendicular to the first direction, and is insulated from the gate line by a gate insulating layer 114. In an exemplary embodiment, a pixel region may be defined by an area in which the gate and data lines cross each other. In another exemplary embodiment, a rectangular shape region formed by neighboring gate and data lines may be a pixel region. A pixel signal is applied to the data line. A pixel signal applied to the data line is supplied to a pixel electrode 112 to be charged while the TFT is turned on by a scan signal applied to the gate line.

The data line may have a single layer structure or a dual layer structure made of a conductive metal.

The TFT includes a gate electrode 113, a semiconductor layer 115, an ohmic contact layer 116, and source and drain electrodes 117 and 118. The gate electrode 113 is connected to the gate line and arranged on a substrate 111. While the TFT in the illustrated embodiment includes a bottom gate structure, in an alternative exemplary embodiment, a top gate structure where the gate electrode 113 is arranged on a top portion thereof may also be provided.

The semiconductor layer 115 overlaps the gate electrode 113 with a gate insulating layer 114 interposed therebetween. The gate insulating layer 114 may cover the gate line and the gate electrode 113, as well as exposed portions of the substrate 111. The semiconductor layer 115 may be made of poly crystalline silicon or amorphous silicon (“a-Si”). The semiconductor layer 115 forms a channel to transmit a pixel signal from the source electrode 117 to the drain electrode 118 while a scan signal is applied to the gate electrode 113.

The ohmic contact layer 116 is formed on the semiconductor layer 115. The ohmic contact layer 116 may be made of doped poly crystalline silicon or doped a-Si. The ohmic contact layer 116 is formed such that an ohmic contact is formed between the semiconductor layer 115 and each of the source and drain electrodes 117 and 118, thereby improving a characteristic of the TFT. The ohmic contact layer 116 may decrease contact resistance of the source and drain electrodes 117 and 118 and the semiconductor layer 115, and reduce a difference of work function therebetween, thereby improving characteristics of the TFT.

The source electrode 117 has one end connected to the data line and the other end overlapping a portion of the semiconductor layer 115. The drain electrode 118 has one end connected to the pixel electrode 112 and the other end overlapping a portion of the semiconductor layer 115. The source and drain electrodes 117 and 118 face each other, and are separated from each other.

A protective layer 119 may be formed over the TFT and over exposed portions of the gate insulating layer 114. The pixel electrode 112 is connected to the drain electrode 118 via a contact hole C formed through the protective layer 119, so that the pixel electrode 112 receives a pixel signal from the drain electrode 118. The pixel electrode 112 transmits light emitted from a backlight unit and may be made of a transparent conductive material such as ITO, IZO, and ITZO.

FIG. 4 is a cross-sectional view illustrating an exemplary opposite substrate according to an exemplary embodiment of the present invention. The opposite substrate 120 is arranged opposite to the TFT array substrate 110. The opposite substrate 120 includes a black matrix 122 formed corresponding to the pixel regions, a color filter 124 and a common electrode 126.

The black matrix 122 is made of an opaque material which can not transmit light. The black matrix 122 partitions the opposite substrate 120 corresponding to the pixel region. For example, the black matrix 122 may be formed on the opposite substrate 120 in areas overlapping the gate and data lines and the TFTs when the opposite substrate 120 is formed with the TFT substrate 110. The color filter 124 is arranged in a region partitioned by the black matrix 122. Alternatively, the color filter 124 may slightly overlap the black matrix 122. The color filter 124 is arranged such that the neighboring color filters 124 have different colors.

An overcoat layer 128 is formed to form a planarized surface on the black matrix 122 and the color filter 124. The overcoat layer 128 may be made of an organic material.

A common electrode 126 is formed on the overcoat layer 128. A common voltage as a reference voltage is applied to the common electrode 126 to drive the liquid crystal layer 130. The common electrode 126 is made of a transparent conductive material such as ITO, IZO, and ITZO.

With reference again to FIG. 2, a liquid crystal is injected into a space formed by sealing the TFT array substrate 110 and the opposite substrate 120 through a sealant 160, forming the liquid crystal layer 130. An alignment direction of liquid crystal molecules in the liquid crystal layer 130 is changed by an electric field formed by the pixel electrode 112 and the common electrode 126. In an exemplary embodiment of the present invention, a twist nematic (“TN”) mode liquid crystal is used as the liquid crystal layer 130.

The common voltage transmitting portion 140 is arranged in an edge portion of the LCD device 100 between the TFT array substrate 110 and the opposite substrate 120. The common voltage transmitting portion 140 may be formed outside of the sealant 160, so that the common voltage transmitting portion 140 is not within the liquid crystal layer 130. The common voltage transmitting portion 140 transmits a common voltage to the opposite substrate 120 from the TFT array substrate 110. That is, the common voltage transmitting portion 140 transmits a common voltage, which is supplied from an external portion to one side of the TFT array substrate 110, to the common electrode 126 arranged on the opposite substrate 120. The common voltage transmitting portion 140 is made of a conductive material.

A polarity of a common voltage is periodically changed in order to prevent deterioration of the liquid crystal layer 130. Noise occurs by such a common voltage swing phenomenon. A level of noise of an audible frequency band becomes high particularly in the common voltage transmitting portion 140 for transmitting a common voltage to the opposite substrate 120.

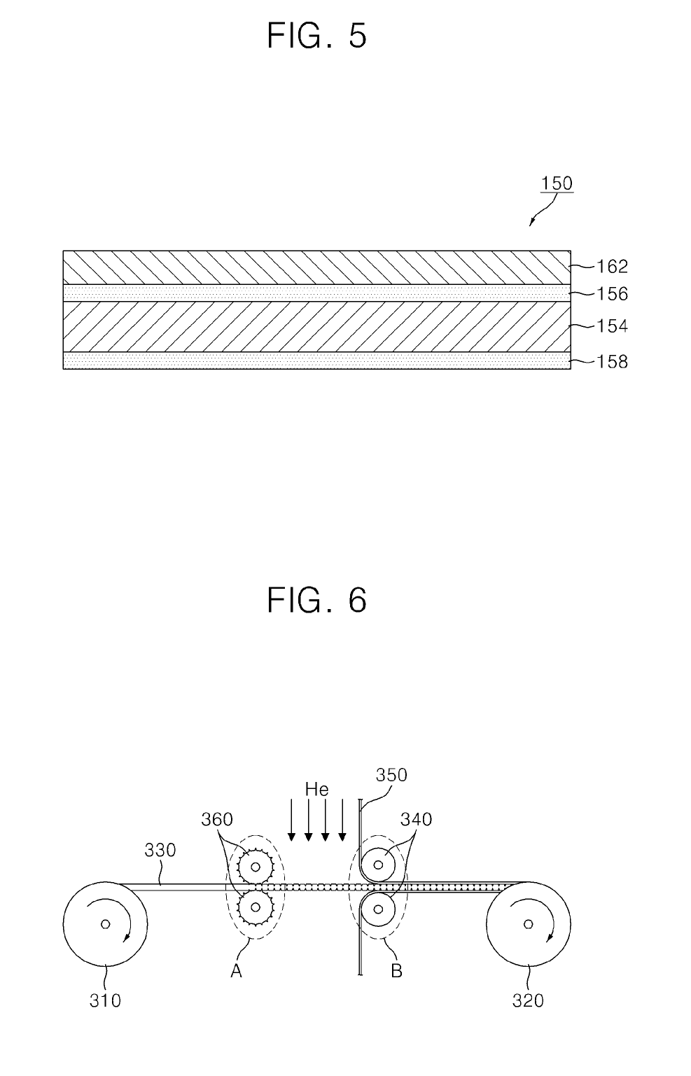

FIG. 5 is a cross-sectional view illustrating an exemplary polarizer film according to the exemplary embodiment of the present invention. The polarizer film 150 includes an extending portion 152, shown in FIG. 2, to cover and overlap the common voltage transmitting portion 140. In the conventional art, a polarizer film covers a liquid crystal distributing region through which an image is displayed. However, in the exemplary embodiment of the present invention, the extending portion 152 serves to extend the polarizer film 150 to an edge of the substrate to thereby cover and overlap with the common voltage transmitting portion 140. Noise occurred in the common voltage transmitting portion 140 is refracted or reflected by the polarizer film 150 having the extended length, so that noise is not directed to a user. Thus, most of noise to be directed toward a user is removed.

The polarizer film 150 is arranged on either or both of the TFT array substrate 110 and the opposite substrate 120. In a TN mode LCD device, the polarizer film 150 is usually arranged on both of the TFT array substrate 110 and the opposite substrate 120. The polarizer films arranged on the two substrates are arranged such that a polarizing direction is perpendicular to each other. Since the polarizer film 150 transmits only light which oscillates in a certain direction, the two polarizer films 150 arranged to be perpendicular to each other block all light. The LCD device 100 displays an image by the liquid crystal layer 130 which changes an oscillating direction of light between the two polarizer films 150.

The polarizer film 150 may have various structures. The polarizer film 150 according to an exemplary embodiment of the present invention includes a polarizing layer 162, a retardation film 154, a first adhesive layer 156, and a second adhesive layer 158. The first adhesive layer 156 adheres the polarizing layer 162 and the retardation film 154 to each other, and the second adhesive layer 158 is formed on a bottom of the retardation film 154 to adhere the polarizer film 150 to either the TFT array substrate 110 or the opposite substrate 120.

In the polarizer film 150, the noise preventing film 1 of FIG. 1 is contained in at least one of the polarizing layer 162, the retardation film 154, the first and second adhesive layers 156 and 158.

An exemplary method for manufacturing the exemplary noise preventing film according to an exemplary embodiment of the present invention is described below with reference to FIGS. 6 to 8.

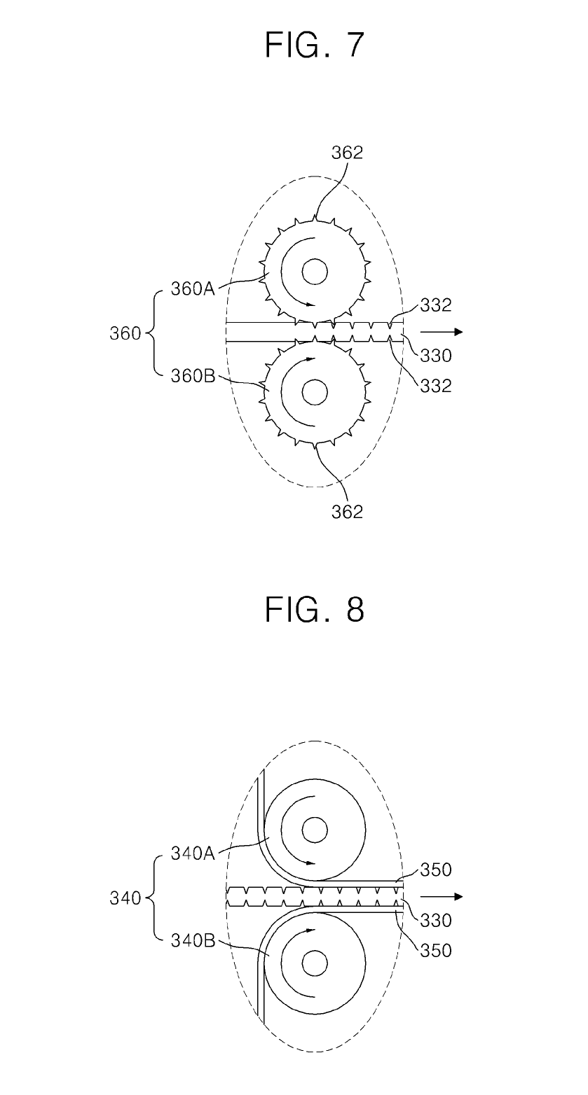

FIG. 6 is a side view illustrating an exemplary method for manufacturing the exemplary noise preventing film according to an exemplary embodiment of the present invention, FIG. 7 is an enlarged view illustrating portion A of FIG. 6, and FIG. 8 is an enlarged view illustrating portion B of FIG. 6.

The noise preventing film 1 according to exemplary embodiments of the present invention has a film form with flexibility, and so it may be manufactured by a roll-to-roll method as shown in FIG. 6, leading to high productivity. In an exemplary method of manufacturing, a first film 330 having a base layer of a predetermined thickness is mounted to a film supplying roll 310, and a film collecting roll 320 is arranged at an opposite side to the film supplying roll 310. The film supplying roll 310 and the film collecting roll 320 rotate together, so that the first film 330 is transferred at a predetermined speed from the film supplying roll 310 to the film collecting roll 320.

A process for attaching the first film 330 to a second film 350 and a process for forming a certain shape in the first film 330 are performed while the first film 330 is transferred at a predetermined speed.

The process for attaching the second film 350 to the first film 330 is performed by using an attaching roll 340 as shown in FIG. 8. That is, the second film 350 supplied from an external portion is pressurized to be attached to the first film 330, supplied from the film supplying roll 310, by the attaching roll 340. If the second film 350 is attached to both surfaces of the first film 330, the attaching roll 340 may be arranged above and below the first film 330, respectively. In other words, a first attaching roll 340A may be arranged above a first surface of the first film 330, and a second attaching roll 340B may be arranged below a second surface of the first film 330. Each attaching roll 340 may then supply a second film 350 to the first and second surfaces of the first film 330, respectively.

A pattern of a predetermined shape may be formed in the first film 330. For example, a groove 332 of a predetermined size may be formed in the first film 330, and then helium (He) may be injected into the groove 332 to form a bubble. As shown in FIG. 7, a groove forming roll 360 is used to form the groove 332 in the first film 330. To this end, the groove forming roll 360 has a plurality of protruding portions 362 which are regularly or irregularly formed on a surface thereof. A surface of the first film 330 is pressurized by the protruding portions 362 of the groove forming roll 360 to thereby form the grooves 332.

If the grooves are formed on both surfaces of the first film 330, the groove forming roll 360 may be arranged above and below the film 330, respectively. In other words, a first groove forming roll 360A may be arranged above a first surface of the first film 330, and a second groove forming roll 360B may be arranged below a second surface of the first film 330. Each groove forming roll 360 may then form grooves 332 to the first and second surfaces of the first film 330, respectively.

The groove forming process may be performed in a chamber which is filled with helium (He) gas or in a helium gas shower atmosphere. Also, the groove forming roll 360 may be arranged prior to the attaching roll 340, such that, in this state, the second film 350 is attached to the first film 330 having the grooves 332, so that helium gas is arrested in spaces between the films 330 and 350, i.e., in the grooves 332, forming bubbles 44 for the noise preventing film 1.

Alternatively, the noise preventing layer may be manufactured such that a paste is first stirred to be mixed in a chamber which is filled with helium gas to form a paste having helium bubbles randomly distributed, and then the paste having helium bubbles is coated on the first film 330 at a predetermined thickness.

As described above, according to the present invention, noise that occurs due to a common voltage swing is significantly reduced by the noise preventing layer. In addition, the polarizer film has the extending portion to cover the common voltage transmitting portion, and thus noise occurring in the common voltage transmitting portion is removed.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A noise preventing film, comprising:
a base layer;
a conductive layer stacked on the base layer;
a noise preventing layer stacked on the conductive layer; and
a noise preventing particle distributed in the noise preventing layer.

2. The noise preventing film of claim 1, wherein the noise preventing particle comprises a conductive particle.

3. The noise preventing film of claim 2, wherein the conductive particle comprises a nickel particle or a nickel-gold alloy particle.

4. The noise preventing film of claim 2, wherein the conductive particle comprises a carbon fiber.

5. The noise preventing film of claim 1, wherein the noise preventing particle comprises a bubble filled with low density gas, and the low density gas has lower density than air.

6. The noise preventing film of claim 5, wherein the low density gas is helium (He).

7. The noise preventing film of claim 1, wherein the noise preventing particle comprises a conductive particle and a bubble filled with low density gas.

8. A liquid crystal display device, comprising:
a thin film transistor array substrate having a thin film transistor array;
an opposite substrate arranged opposite to the thin film transistor array substrate and having a common electrode;
a liquid crystal layer injected between the thin film transistor array substrate and the opposite substrate;
a common voltage transmitting portion arranged in an edge portion of the thin film transistor array substrate and the opposite substrate and transmitting a common voltage supplied from the thin film transistor array substrate to the opposite substrate;
a polarizer film attached on at least one of the thin film transistor array substrate and the opposite substrate; and
a noise preventing film that prevents noise, is arranged in the polarizer film, and includes a base layer, a conductive layer stacked on the base layer, a noise preventing layer stacked on the conductive layer, and a noise preventing particle distributed in the noise preventing layer.

9. The LCD device of claim 8, wherein the polarizer film comprises an extending portion that covers the common voltage transmitting portion to block noise occurring in the common voltage transmitting portion.

10. The LCD device of claim 8, wherein the polarizer film comprises a polarizing layer, a retardation film, a first adhesive layer that attaches the polarizing film and the retardation film to each other, and a second adhesive layer adhered to an outer surface of the retardation film.

11. The LCD device of claim 10, wherein the noise preventing film is arranged in at least one of the polarizing layer, the retardation film, and the first and second adhesive layers.

12. The LCD device of claim 8, wherein the noise preventing particle comprises a conductive particle.

13. The LCD device of claim 12, wherein the conductive particle comprises a nickel particle or a nickel-gold alloy particle.

14. The LCD device of claim 12, wherein the conductive particle comprises a carbon fiber.

15. The LCD device of claim 12, wherein the noise preventing particle comprises a bubble filled with low density gas, and the low density gas has lower density than air.

16. The LCD device of claim 15, wherein the low density gas is helium (He).

17. The LCD device of claim 8, wherein the noise preventing particle comprises a conductive particle and a bubble filled with low density gas.

18. A method for manufacturing a noise preventing film, the method comprising:
moving a first film at a predetermined speed;
forming a groove on at least one surface of the first film; and
attaching a second film to a groove-formed surface of the first film in a low density gas atmosphere.

19. The method of claim 18, wherein the groove is formed on first and second opposing surfaces of the first film.

20. The method of claim 19, wherein the second film is attached to the first surface of the first film, and the second film is attached to the second surface of the first film.

21. The method of claim 18, wherein the low density gas in the low density gas atmosphere is helium (He).

22. The method of claim 18, wherein the second film is attached to the first film in a chamber filled with low density gas.

23. The method of claim 18, wherein the second film is attached to the first film in a low density gas shower atmosphere.
